(19) United States
(12) Patent Application Publication
(10) Pub. No.: US 2007/0242750 A1
(43) Pub. Date: Oct. 18, 2007

(54) Motion Estimation In Interlaced Video Images

(75) Inventors: Gerard De Haan, Eindhoven (NL); Calina Ciuhu, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,173

(22) PCT Filed: May 17, 2005
(86) PCT No.: PCT/IB05/51595

§ 371 Date: Nov. 16, 2006

(30) Foreign Application Priority Data
May 25, 2004 (EP) 04102292.2

(51) Int. Cl. H04N 7/26

(52) U.S. Cl. 375/240.16

(57) ABSTRACT

The invention relates to a method, a device, and a computer programme product for calculating a motion vector from an interlaced video signal with interpolating a first pixel sample from a first set of pixels and a second set of pixels using a first motion vector, and interpolating a second pixel sample from the first set of pixels and a third set of pixels using a second motion vector. To improve motion estimation and de-interlacing, the invention provides interpolating pixels of the first set of pixels to calculate a third pixel sample as an average of at least two pixels within the first set of pixels, calculating a first relation between the first pixel sample and the third pixel sample, calculating a second relation between the second pixel sample and the third pixel sample, and selecting an output motion vector from a set of motion vectors by minimising the first and second r elation using the set of motion vectors.

The invention relates to a method, a device, and a computer programme product for calculating a motion vector from an interlaced video signal comprising calculating a first pixel sample from a first set of pixels and a second set of pixels using a first motion vector, and calculating a second pixel sample from the first set of pixels and a third set of pixels using a second motion vector.

De-interlacing is the primary resolution determination of high-end video display systems to which important emerging non-linear scaling techniques can only add finer detail. With the advent of new technologies, like LCD and PDP, the limitation in the image resolution is no longer in the display device itself, but rather in the source or transmission system. At the same time, these displays require a progressively scanned video input. Therefore, high quality de-interlacing is an important pre-requisite for superior image quality in such display devices.

A first step to de-interlacing is known from P. Delonge, et al., “Improved Interpolation, Motion Estimation and Compensation for Interlaced Pictures”, IEEE Tr. on Im. Proc., Vol. 3, no. 5, September 1994, pp 482-491.

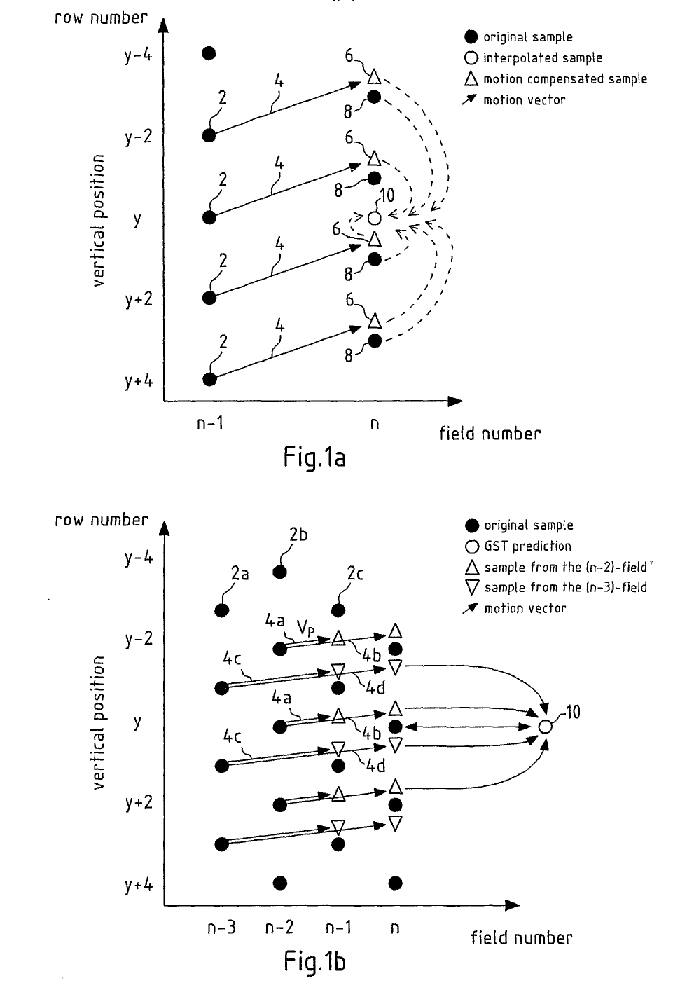

This method is also known as the general sampling theorem (GST) de-interlacing method. The method is depicted in FIG. 1A. FIG. 1A depicts a field of pixels 2 in a vertical line on even vertical positions y+4−y−4 in a temporal succession of n−1-n.

For de-interlacing, two independent sets of pixel samples are required. The first set of independent pixel samples is created by shifting the pixels 2 from the previous field n−1 over a motion vector 4 towards a current temporal instance n into motion compensated pixel samples 6. The second set of pixels 8 is located on odd vertical lines y+3-y−3 of the current temporal instance n of the image. Unless the motion vector 6 is a so-called “critical velocity”, i.e. a velocity leading to an odd integer pixel displacements between two successive fields of pixels, the pixel samples 6 and the pixels 8 are intended to be independent. By weighting the pixel samples 6 and the pixels 8 from the current field the output pixel sample 10 results as a weighted sum (GST-filter) of samples. The current image may be displayed using pixels 8 from odd lines together with interpolated output pixel samples 10, thereby increasing the resolution of the display.

A motion vector may be derived from motion components of pixels within the video signal. The motion vector represents the direction of motion of pixels within the video image. A current field of input pixels may be a set of pixels, which are temporal currently displayed or received within the video signal. A weighted sum of input pixels may be acquired by weighting the luminance or chrominance values of the input pixels according to interpolation parameters.

Mathematically, the output pixel sample 10 may be described as follows. Using F(\vec{x},n) for the luminance value of a pixel at position \vec{x} in image number n, and using Fᵢ for the luminance value of interpolated pixels at the missing line (e.g. the odd line) the output of the GST de-interlacing method is as:
Fᵢ^{n,n-1}(\vec{x},n)=ΣₖF(\vec{x}−(2k+1)\vec{u}_{y},n)h₁(k,δ_{y})+ΣₘF(\vec{x}−\vec{e}(\vec{x},n)−2m\vec{u}_{y},n−1)h₂ (m,δ_{y})
with h₁ and h₂ defining the GST-filter coefficients. The first term represents the current field n and the second term represents the previous field n−1. The motion vector, \vec{e}(\vec{x},n) is defined as:

$$\vec{e} ( \vec{x} , n ) = ( \begin{matrix}{d}_{x} ( \vec{x} , n ) \\ 2 Round ( \frac{{d}_{y} ( \vec{x} , n )}{2} )\end{matrix} )$$

with Round ( ) rounding to the nearest integer value and the vertical motion fraction δ_{y} defined by:

$${δ}_{y} ( \vec{x} , n ) - \vert {d}_{y} ( \vec{x} , n ) - 2 Round ( \frac{{d}_{y} ( \vec{x} , n )}{2} ) \vert$$

The GST-filter, composed of the linear GST-filters h₁ and h₂, depends on the vertical motion fraction δ_{y}(\vec{x},n) and on the sub-pixel interpolator type.

Although for video applications, a non-separable GST filter, composed of h_{1,}and h₂, depending on both the vertical and horizontal motion fraction δ_{y}(\vec{x},n) and δₓ(\vec{x},n) is more adequate, the vertical component δ_{y}(\vec{x},n) may only be used.

Delonge proposed to just use vertical interpolators and thus use interpolation only in the y-direction. If a progressive image F^{p} is available, F^{e} for the even lines could be determined from the luminance values of the odd lines F^{o} in the z-domain as:
F^{e}(z,n)=(F^{p}(z,n−1)H(z))ₑ=F^{o}(z,n−1)H^{o}(z)+F^{e}(z,n−1)H^{e}(z)
where F^{e} is the even image and F^{o} is the odd image. Then F^{o} can be rewritten as:

$${F}^{o} ( z , n - 1 ) = \frac{{F}^{o} ( z , n ) - {F}^{e} ( z , n - 1 ) {H}^{o} ( z )}{{H}^{e} ( n )}$$

which results in:
F^{e}(z,n)=H₁(z)F^{o}(z,n)+H₂(z)F^{e}(z,n−1).
The linear interpolators can be written as:

$${H}_{1} ( z ) = \frac{{H}^{o ( z )}}{{H}^{e ( z )}}$$

$${H}_{2} ( z ) = {H}^{e ( z )} \frac{{( {H}^{o ( z )} )}^{2}}{{H}^{e ( z )}}$$

When using sinc-waveform interpolators for deriving the filter coefficients, the linear interpolators H₁(z) and H₂(z) may be written in the k-domain

$${h}_{1} ( k ) = {( - 1 )}^{k} sin c ( π ( k - \frac{1}{2} ) ) \frac{sin ( {πδ}_{y} )}{cos ( {πδ}_{y} )}$$

$${h}_{2} ( k ) = {( - 1 )}^{k} \frac{sin c ( π ( k + {δ}_{y} ) )}{cos ( {πδ}_{y} )} .$$

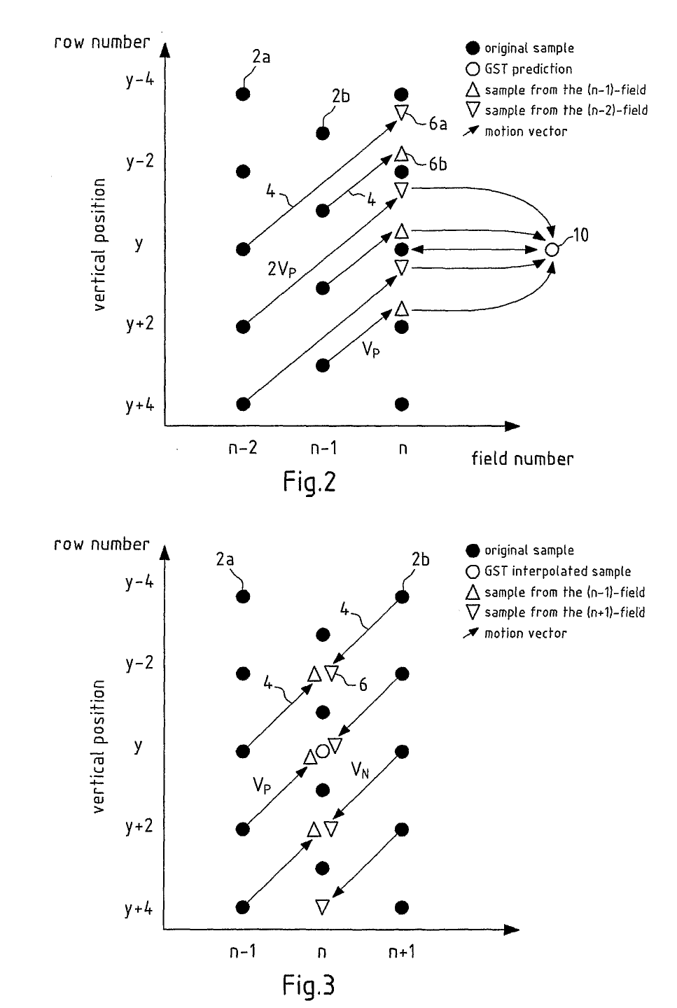

P. Delonge, et al. also proposed an interpolation as shown in FIG. 2. This interpolation is based on the assumption that the motion between two successive fields is uniform. The method uses pixels 2a from a pre-previous sample n−2 and pixels 2b from a previous sample n−1, shifted over a common motion vector 4. The motion compensated pixel values 6a, 6b may be used to estimate a pixel sample value 10. However, the correlation between the current field and the n−2 field is smaller, as the temporal distance between the samples is larger.

To provide improved interpolation, for example in case of incorrect motion vectors, it has been proposed to use a median filter. The median filter allows eliminating outliners in the output signal produced by the GST-interlacing method.

However, the performance of a GST-interpolator is degraded in areas with correct motion vectors when applying a median filter. To reduce this degradation, it has been proposed to selectively apply protection (E. B. Bellers and G. de Haan, “De-interlacing: a key technology for scan rate conversion”, Elsevier Science book series “Advances in Image Communications”, vol. 9, 2000). Areas with near the critical velocity are median filtered whereas other areas are GST-interpolated. The GST de-interlacer produces artefacts in areas with motion vectors near the critical velocity. Consequently, the proposed median protector is applied for near critical velocities as follows:

$${F}_{i} ( \vec{x} , n ) = \{ \begin{matrix}MED \{ \begin{matrix}F ( \vec{x} + \vec{{u}_{y}} , n ) , \\ {F}_{GST} ( \vec{x} , n ) , F ( \vec{x} - \vec{{u}_{y}} , n )\end{matrix} \} , & ( 0 , 5 \leq \vert {δ}_{y} \vert < 1 ) \\ {F}_{GST} ( \vec{x} , n ) , & ( otherwise )\end{matrix}$$

where F_{GST} represents the output of the GST de-interlacer.

The drawback of this method is that with current a GST de-interlacer only a part of the available information is used for interpolating the missing pixels. As in video signals spatio-temporal information is available, it should be possible to use information from different time instances and different sections of a video signal to interpolate the missing pixel samples.

It is therefore an object of the invention to provide a more robust de-interlacing. It is a further object of the invention to use more of the available information provided within a video signal for interpolation. It is yet another object or the invention to provide better de-interlacing results. It is another object of the invention to provide improved motion vectors from interlaced video signals for enhanced image processing.

To overcome these drawbacks, embodiments provide a method for providing a motion vector from an interlaced video signal comprising calculating a first pixel sample from a first set of pixels and a second set of pixels using a first motion vector, calculating a second pixel sample from the first set of pixels and a third set of pixels using a second motion vector, calculating a third pixel sample from the first set of pixels, calculating a first relation between the second pixel sample and the third pixel sample, calculating a second relation between the first and/or the second pixel sample and the third pixel sample, and selecting an output motion vector from a set of motion vectors by minimising the first and second relation using the set of motion vectors.

Calculating the pixel samples may be done by interpolating the respective pixels.

The calculated motion vector may, according to embodiments, be used for de-interlacing or motion compensated noise reduction, or any other image enhancement.

The third pixel sample may be calculated by interpolating pixels of the first set s of pixels as an average of at least two pixels from within the first set of pixels.

Embodiments involve the current field during interpolation. The selection of the correct motion vector may, according to embodiments, also rely on pixels of the currently interlaced field as well. Embodiment allow to compare motion compensated pixel samples from the previous and next field in order to obtain the correct motion vector, but also to compare these pixel samples with pixel samples from the current field.

Exemplarily, this may be possible by calculating a line average in the current field and calculate the relation between the line average and the first and second pixel samples. The motion estimation criterion may thus choose the correct motion vector by minimising relations between first pixel samples, second pixel samples and third pixel samples.

The vulnerability of motion estimation for vector inaccuracies may be accounted for according to embodiments by combining motion estimation using two GST predictions of previous and next fields with an intra-field minimising criterion, resulting in a more robust estimator.

According to embodiments, calculating a third relation between the first pixel sample and the second pixel sample and selecting an output motion vector from a set of motion vectors by minimising the first, second, and third relation using the set of motion vectors, is provided. Insofar, the relation between pixel sample values of a current, a previous and a next field may be accounted for.

Embodiments provide calculating the third relation as an average of at least two vertically neighbouring pixels within the first set of pixels. By that, errors due to motion vectors with an even number of vertical pixel displacements may be accounted for.

Selecting an output motion vector from a set of motion vectors by minimising a sum of the relations using the set of motion vectors is provided according to embodiments. Minimising the sum may be one error criterion which results in good estimates of motion vectors. The sum may as well be a weighted sum, where the relations may be weighted with values.

Embodiments also provide deriving the first set of pixels, the second set of pixels and the third set of pixels from succeeding temporal instances of the video instance. This allows interlacing video images.

In case the second set of pixels temporally precedes the first set of pixels and/or the third set of pixels temporally follows the first set of pixels, embodiments may account for motion of a pixel over at least three temporal succeeding fields.

One possible error criterion may be that the first, second, and/or third relation is the absolute difference between the pixel sample values. Another possible error criterion may be that the first, second and/or third relation is the squared difference between the pixel sample values.

Providing the pixel samples is possible according to embodiments, insofar that the first pixel sample is interpolated as a weighted sum of pixels from the first set of pixels and the second set of pixels, where the weights of at least some of the pixels depend on a value of a motion vector. According to embodiments the second pixel sample is interpolated as a weighted sum of pixels from the first set of pixels and the third set of pixels, where the weights of at least some of the pixels depend on a value of a motion vector.

A vertical fraction may, according to embodiments, account for weighting values of the first and/or second relation.

Another aspect of the invention is a interpolation device providing a motion vector from an interlaced video signal comprising first calculation means for calculation a first pixel sample from a first set of pixels and a second set of pixels using a first motion vector, second calculation means for calculation a second pixel sample from the first set of pixels and a third set of pixels using a second motion vector, third calculation means for calculating a third pixel sample from the first set of pixels, first calculation means for calculating a first relation between the second pixel sample and the third pixel sample, second calculation means for calculating a second relation between the first and/or the second pixel sample and the third pixel sample, selection means for selecting an output motion vector from a set of motion vectors by minimising the first and second relation using the set of motion vectors.

A further aspect of the invention is a display device comprising such an interpolation device.

Another aspect of the invention is a computer programme and a computer programme product for providing a motion vector from an interlaced video signal comprising instructions operable to cause a processor to calculate a first pixel sample from a first set of pixels and a second set of pixels using a first motion vector, calculate a second pixel sample from the first set of pixels and a third set of pixels using a second motion vector, calculate a third pixel sample from the first set of pixels, calculate a first relation between the second pixel sample and the third pixel sample, calculate a second relation between the first and/or the second pixel sample and the third pixel sample, and select an output motion vector from a set of motion vectors by minimising the first and second relation using the set of motion vectors.

These and other aspects of the invention will be apparent from and elucidated with reference to the following Figures. In the Figures show:

FIG. 1A schematically a GST interpolation using preceding fields;

FIG. 1B schematically a GST interpolation using four successive fields;

FIG. 2 schematically a GST interpolation using pre-preceding and preceding fields;

FIG. 3 schematically a motion estimation with a motion vector with a displacement of an even number of pixels per picture;

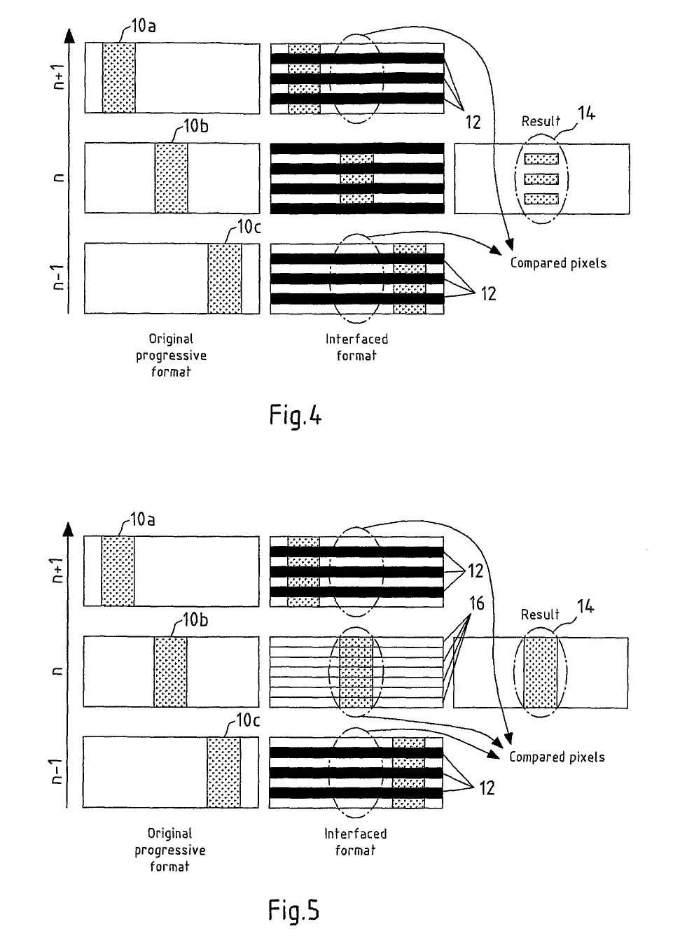

FIG. 4 motion estimation with a conventional error criterion;

FIG. 5 improved motion estimation with an additional criterion based on a current field; and

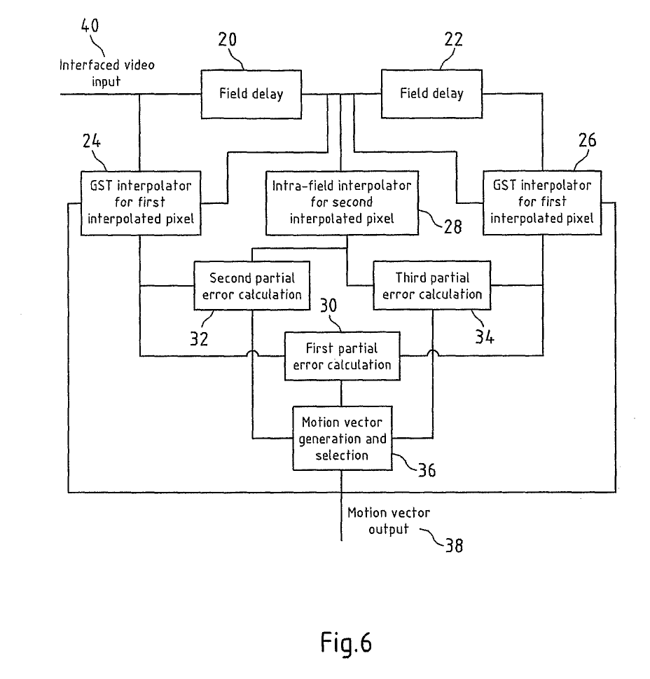

FIG. 6 block diagram of a motion estimator.

A motion estimation method relying on samples situated at equal distances from the current field, which may be the previous, and the next temporal instance, provides improved results. The motion estimation criterion may be based on the fact that the luminance or chrominance value of a pixel may not only be based on an estimation from a previous field n−1, but also on an existing pixel in the current field n and the shifted samples from the next field n+1.

The output of the GST filter may be written as
i Fᵢ^{n,n-1}=ΣₖF(\vec{x}−(2k+1)\vec{u}_{y},n)h₁(k,δ_{y})+ΣₘF(\vec{x}−\vec{e}(\vec{x},\vec{n})−2m\vec{u}_{y},n+1)h₂(m,δ_{y})

Under the assumption that the motion vector is linear over two fields, the motion vector with the corresponding vertical and horizontal motion fraction δ_{y}(\vec{x},n) and δₓ(\vec{x},n) may be calculated by using an optimisation criterion

$$\vert {F}_{{\vec{v}}_{N} = - {\vec{v}}_{P}}^{n , n - 1} ( x , y , n ) - {F}_{{\vec{v}}_{P}}^{n , n + 1} ( x , y , n ) \vert = MINIMUM$$

for all (x,y) belonging to a block of pixels, for instance a 8×8 block.

For motion vectors with an even number of pixel displacement, between two fields, that is δ_{y}(\vec{x},n)=0, the output of motion estimation from a previous or a next field reduces to
F^{n,n-1}(x,y,n)=F(\vec{x}+\vec{v_{P}},n−1)
and
F^{n,n+1}(x,y,n)=F(\vec{x}+\vec{v_{N}},n+1)

Insofar, only shifted pixels from the previous n−1 and the next n+1 field are taken into account, resulting in a two field motion estimator. The minimisation, as pointed out above, thus may only take neighbouring pixels into account, without involving pixels from the current field n, as is depicted in FIG. 3.

FIG. 3 depicts the vulnerability of current motion estimation only using estimated pixel values from the current and the next frame. The minimisation criterion may take into account shifted pixels 2a from the previous frame n−1 and shifted pixels 2b from the next frame n+1. Using motion vector 4, estimates of pixel values 6 may be calculated. In case the motion vector 4 corresponds to an even number of pixel displacement per picture, the minimisation criterion

$$\vert {F}_{{\vec{v}}_{N} = - {\vec{v}}_{P}}^{n , n - 1} ( x , y , n ) - {F}_{\vec{V} P}^{n , n + 1} ( x , y , n ) \vert = MINIMUM$$

may result in a local minimum for thin moving objects, which does not correspond to the real motion vector.

Such a local minimum can be seen in FIG. 4. FIG. 4 shows three temporal instances n−1, n, n+1 of an image 10a, 10b, 10c. In case of a displacement of an even number of pixels per image, it may happen that the interpolation of the compared pixels 12 may result in an image 14, which does not correspond to the real image. The estimation criterion, only taking the previous and the following image, or the previous and pre-previous images, as P. Delonge proposes, into account, may thus result in an image not corresponding to the real image without interpolation.

P Delogne's proposal provides a solution that overcomes the even-vectors problem in motion estimation. This solution, described in P. Delogne, et al., Improved interpolation, Motion Estimation and Compensation for Interlaced Pictures, IEEE Tr. On Im. Proc., Vol. 3, no. 5, September 1994, pp 482-491, is depicted in FIG. 1B, and is based in motion estimation and compensation for four successive fields n−3 to n. Thus, when the three-field solution only compares samples from the n and n−2 along even motion vector 4b, the four-field solution involves necessarily also the intermediary, n−1 field, by comparing it with the n−3 field using motion vector 4c.

The main drawback of this solution is the fact that it extends the requirement of uniformity of the motion over two successive frames, that means over three successive fields. This is a strong limitation for the practical case of sequences with rather non-uniform motion.

A second drawback is in the hardware implementation, because this method requires an extra field memory (the n−3 field). In addition, a larger cache is needed, due to the fact that the motion vector 4c that shifts samples from the n−3 field over to the n field is three times larger than the motion vector that shifts samples over two successive fields.

From FIG. 5, wherein like numerals refer to like elements, an interpolation according to embodiments may be seen. As can be seen, the same image 10 is interpolated for frame n. However, according to this embodiment, not only pixels 12 from preceding 10a and following 10c images are used to interpolate image 14, but also the current image 10b is used.

In order to prevent the effect of discontinuities due no non consistent motion vector estimation, pixels from the current field 16 are as well taken into account. Each GST prediction from the next or previous field may additionally be compared with the result of a line average LA of the current field. The motion estimation criterion may be

$$\vert {N}_{{\vec{v}}_{N} = {\vec{v}}_{P}} ( x , y , n ) - {P}_{{\vec{v}}_{P}} ( x , y , n ) \vert + \\ \vert {N}_{{\vec{v}}_{N} = {\vec{v}}_{P}} ( x , y , n ) - {P}_{{\vec{v}}_{P}} ( x , y , n ) \vert + \\ \vert {P}_{{\vec{v}}_{P}} ( x , y , n ) - LA ( x , y , n ) \vert = MINIMUM$$

where N is the estimate pixel value 12 from the next image 10c, P is the estimated pixel value 12 from the previous image 10a and LA(x,y,n) is the intra-field interpolated pixel 16 at the position (x,y) in the current image 10a, using a simple line average (LA). The resulting image 14 is shown in FIG. 5.

The additional terms in the minimisation, which include the line average LA in the current field allow increasing the robustness against errors of motion vectors. They allow preventing matching black to black from both sides of the spoke in the example according to FIG. 5. The line average terms LA ensures that black is also matched to the spoke for an incorrect motion vector.

The line average terms may also have an weighting factor that depends on the value of the vertical fraction. This factor has to ensure that these terms have a selectively larger contribution for motion vectors close to an even value. Thus, the minimisation criterion might be written as:

$$\vert {N}_{\vec{v} N = \vec{v} P} ( x , y , n ) \vert + ( 1 - {δ}_{y} ) ( \vert {N}_{\vec{v} N = \vec{v} P} ( x , y , n ) - LA ( x , y , n ) \vert + \vert LA ( x , y , n ) - {P}_{\vec{v} P} ( x , y , n ) \vert ) = MINIMUM$$

FIG. 6 shows a block diagram of an implementation of a de-interlacing method. Depicted is an input signal 40, a first field memory 20, a second field memory 22, a first GST-interpolator 24, a second GST-interpolator 26, an intra-field interpolator 28, a first partial error calculator 30, a second partial error calculator 32, a third partial error calculator 34, selecting means 36, and an output signal 38.

At least a segment of the input signal 40 may be understood as second set of pixels. At least a segment of the output of field memory 20 may be understood as first set of pixels and at least a segment of the output of field memory 22 may be understood as third set of pixels. A set of pixels may be a block of pixels, for instance an 8×8 block.

When a new image is fed to the field memory 20, the previous image may already be at the output of filed memory 20. The image previous to the image output at field memory 20 may be output at field memory 22. In this case, three temporal succeeding instances may be used for calculating the GST-filtered interpolated output signal.

Input signal 40 is fed to field memory 20. In field memory 20, a motion vector is calculated. This motion vector depends on pixel motion within a set of pixels of the input signal. The motion vector is fed to GST interpolator 24. Also input signal 40 is fed to GST interpolator 24.

The output of the first field memory 20 is fed to the second field memory 22. In the second field memory a second motion vector is calculated. The temporal instance for this motion vector is temporally succeeding the instance of the first field memory 20. Therefore, the motion vector calculated by field memory 22 represents the motion within a set of pixels within an image succeeding the image used in field memory 20. The motion vector is fed to GST-interpolator 26. Also the output of field memory 20 is fed to GST-interpolator 26.

The output of field memory 20 represents the current field. This output may be fed to intra-field interpolator 28. Within intra-field interpolator 28, a line average of vertically neighbouring pixels may be calculated.

GST-interpolator 24 calculates a GST filtered interpolated pixel value based on its input signals which are the input signal 40, the motion vector from field memory 20 and the output of the field memory 20. Therefore, the interpolation uses two temporal instances of the image, the first directly from the input signal 40 and the second preceding the input signal 40 by a certain time, in particular the time of one image. In addition, the motion vector is used.

GST-interpolator 26 calculates a GST filtered interpolated pixel value based on its input signals which are the output of field memory 20, and the output of field memory 22. In addition GST-filter 26 uses the motion vector calculated within field memory 22. The GST filtered interpolated output is temporally preceding the output of GST filter 24. In addition, the motion vector is used.

In line averaging means 28, the average of two neighbouring pixel values on a vertical line may be averaged. These pixel values may be neighbouring the pixel value to be interpolated.

The output of GST filter 24 may be written as:
Fᵢ₁(\vec{x},n)=ΣₖF(\vec{x}−(2k +1)\vec{u}_{y},n)h₁(k,δ_{y})+ΣₘF(\vec{x}−\vec{e}(\vec{x},n)−2m\vec{u}_{y},n+1)h₂(m,δ_{y}).

The output of GST filter 26 may be written as:
Fᵢ₂(\vec{x},n)=ΣₖF(\vec{x}−(2k +1)\vec{u}_{y},n)h₁(k,δ_{y})+ΣₘF(\vec{x}+\vec{e}(\vec{x},n)+2m\vec{u}_{y},n+1)h₂(m,δ_{y}).

The absolute difference between the outputs of the GST interpolators 24, 26 is calculated in the first error calculator 30.

The absolute difference between the outputs of the GST interpolators 24 and the line average calculator 28 is calculated in the second error calculator 32.

The absolute difference between the outputs of the GST interpolators 26 and the line average calculator 28 is calculated in the third error calculator 34.

The output of the first, second and third error calculators 30, 32, 34 is fed to selection means 36. Within selection means the motion vector with the minimum error value is selected from

$$\vert {N}_{{\vec{v}}_{N} = - {\vec{v}}_{P}} ( x , y , n ) - {P}_{{\vec{v}}_{P}} ( x , y , n ) \vert + \vert {N}_{{\vec{v}}_{N} = - {\vec{v}}_{P}} ( x , y , n ) - LA ( x , y , n ) \vert + \vert {P}_{{\vec{v}}_{P}} ( x , y , n ) - LA ( x , y , n ) \vert = MINIMUM$$

The set of motion vector may be fed back to GST-interpolators 24, 26, to allow calculating different partial errors for different motion vectors. For these different motion vectors the minimisation criterion may be used to select the motion vector yielding the best results, e.g. the minimum error.

Such, the motion vector yielding the minimum error may be selected to calculate the interpolated image. The resulting motion vector is put out as output signal 38.

With the inventive method, computer programme and display device the image quality may be increased.

1. Method for calculating a motion vector from an interlaced video signal, in particular for de-interlacing, comprising:
calculating a first pixel sample from a first set of pixels and a second set of pixels using a first motion vector,
calculating a second pixel sample from the first set of pixels and a third set of pixels using a second motion vector,
calculating a third pixel sample from the first set of pixels,
calculating a first relation between the first pixel sample and the second pixel sample,
calculating a second relation between the first and/or the second pixel sample and the third pixel sample, and
selecting an output motion vector from a set of motion vectors by minimising the first and second relation using the set of motion vectors.

2. The method of claim 1, comprising calculating a third relation between the first pixel sample and the second pixel sample and selecting an output motion vector from a set of motion vectors by minimising the first, second, and third relation using the set of motion vectors.

3. The method of claim 1, comprising calculating the third pixel sample as an average of at least two vertically neighbouring pixels within the first set of pixels.

4. The method of claim 2, comprising selecting an output motion vector from a set of motion vectors by minimising a weighted sum of the relations using the set of motion vectors.

5. A method of claim 1, wherein the first set of pixels, the second set of pixels and the third set of pixels are derived from succeeding temporal instances of the video sequence.

6. A method of claim 1, wherein the second set of pixels temporally precedes the first set of pixels and/or wherein the third set of pixels temporally follows the first set of pixels.

7. A method of claim 1, wherein the first, second and/or third relation is the absolute difference between the pixel sample values.

8. A method of claim 1, wherein the first, second and/or third relation is the squared difference between the pixel sample values.

9. A method of claim 1, wherein the first pixel sample is interpolated as a weighted sum of pixels from the first set of pixels and the second set of pixels, where the weights of at least some of the pixels depend on a value of a motion vector.

10. A method of claim 1, wherein the second pixel sample is interpolated as a weighted sum of pixels from the first set of pixels and the third set of pixels, where the weights of at least some of the pixels depend on a value of a motion vector.

11. A method of one of claims 9, wherein the first and/or second motion vector is calculated from a motion of pixels between the first set of pixels and the second set of pixels or between the first set of pixels and the third set of pixels.

12. A method of claim 1, wherein the first and the second relations are weighted with a factor that depends on the value of a vertical fraction.

13. Interpolation device for calculating a motion vector from an interlaced video signal, in particular for de-interlacing, comprising:
first calculation means for calculating a first pixel sample from a first set of pixels and a second set of pixels using a first motion vector,
second calculation means for calculating a second pixel sample from the first set of pixels and a third set of pixels using a second motion vector,
third calculation means for calculating a third pixel sample from the first set of pixels,
first calculation means for calculating a first relation between the first pixel sample and the second pixel sample,
second calculation means for calculating a second relation between the first and/or the second pixel sample and the third pixel sample,
selection means for selecting an output motion vector from a set of motion vectors by minimising the first and second relation using the set of motion vectors.

14. Display device comprising an interpolation device of claim 13.

15. Computer programme for calculating a motion vector from an interlaced video signal, in particular for de-interlacing, comprising instructions operable to cause a processor to:
calculate a first pixel sample from a first set of pixels and a second set of pixels using a first motion vector,
calculate a second pixel sample from the first set of pixels and a third set of pixels using a second motion vector,
calculate a third pixel sample from the first set of pixels,
calculate a first relation between the first pixel sample and the second pixel sample,
calculate a second relation between the first and/or the second pixel sample and the third pixel sample,
select an output motion vector from a set of motion vectors by minimising the first and second relation using the set of motion vectors.

16. Computer program product comprising a computer program of claim 14 stored thereon.
